(19) United States
(12) Patent Application Publication
(10) Pub. No.: US 2017/0169694 A1
(43) Pub. Date: Jun. 15, 2017

(54) Home-Based Intelligent Analysis And Suggestion System And Method Thereof

(71) Applicants: Inventec (Pudong) Technology Corporation, Shanghai (CN); Inventec (Beijing) Electronics Technology Co., Ltd., Beijing (CN)

(72) Inventor: Chaucer Chiu, Taipei (TW)

(21) Appl. No.: 15/073,376

(22) Filed: Mar. 17, 2016

(30) Foreign Application Priority Data
Dec. 15, 2015 (CN) 201510939117.0

(51) Int. Cl. G08B 21/18

(52) U.S. Cl. CPC G08B 21/18

(57) ABSTRACT

A home-based intelligent analysis and suggestion system and a method thereof are disclosed. Multiple sensors are respectively installed at spaces of a house. Measuring data of the sensors are collected by the data collection client. A server is configured to analyze the measuring data and spatial information corresponding thereto to generate a suggestion analysis result. Therefore, the technical effect of providing an intelligent diagnosis for the spaces of the house may be achieved.

### CROSS-REFERENCE TO RELATED APPLICATION

This application claims the benefit of Chinese Patent Application No. 201510939117.0, filed Dec. 15, 2015.

### BACKGROUND OF THE INVENTION

Field of the Invention

The present disclosure relates to a home-based intelligent analysis and suggestion system and a method thereof, more particularly to a system in which a plurality of sensors are installed to collect measuring data which are analyzed in cooperation with spatial information of a house to provide an intelligence analysis and suggestion for home environment.

Description of the Related Art

A problem that a family most does not want to encounter is break of a house caused by disaster, and the most common disaster is fire disaster. However, the general family cannot obtain the condition of the house easily, so the disaster may occur accidently.

In addition, an existing at-home intelligent diagnosis system is designed for a patient, and includes a healthcare device configured to monitor the patient's physiological data, such that an at-home intelligent diagnosis based on the physiological data can be provided to the patient; however, the existing at-home intelligent diagnosis system is helpless for diagnosis of home environment.

In conclusion, the conventional technology problem of the at-home intelligent diagnosis system unable to diagnose the home environment has existed for a long time, so what is need is to provide an improved technology solution to solve the problem.

### SUMMARY OF THE INVENTION

In order to solve the conventional technology problem of the existing at-home intelligent diagnosis system unable to diagnose the home environment, the present disclosure illustrates a home-based intelligent analysis and suggestion system and a method thereof.

According to an exemplary embodiment of the present disclosure, the home-based intelligent analysis and suggestion system includes a plurality of sensors, a data collection client and a server, and the data collection client includes a storage module, a collection client receiving module, a collection client transmitting module and a display-and-print module. The server includes a server receiving module, an analysis module and a server transmitting module.

The plurality of sensors are installed in spaces of a house respectively, and each sensor is measured different measuring data corresponding to one of the spaces.

The storage module storing spatial information of each of the spaces. The collection client receiving module receiving the measuring data measured by the plurality of sensors installed in the spaces, through wireless transmission, and receiving a suggestion analysis result corresponding to the measuring data. The collection client transmitting module transmitting the measuring data and the spatial information through wireless transmission. The display-and-print module displaying and printing out the suggestion analysis result.

The server receiving module receiving the measuring data and the spatial information corresponding thereto from the collection client transmitting module. The analysis module performing an analysis based on the measuring data and the spatial information corresponding thereto, to generate the suggestion analysis result. The server transmitting module transmitting the suggestion analysis result to the collection client receiving module.

According to an exemplary embodiment of the present disclosure, the home-based intelligent analysis and suggestion method includes following steps: installing a plurality of sensors in spaces of a house respectively, and using each of the plurality of sensors to measure different measuring data corresponding to one of the spaces; installing a data collection client in the house and storing spatial information of each of the spaces in the data collection client; receiving the measuring data measured by the plurality of sensors installed in the spaces respectively through wireless transmission in the data collection client; transmitting the measuring data and the spatial information corresponding thereto to a server through wireless transmission in the data collection client; performing an analysis based on the measuring data and the spatial information corresponding thereto to generate a suggestion analysis result in the server; transmitting the suggestion analysis result to the data collection client from the server, and finally displaying and printing out the suggestion analysis result in the data collection client.

The difference between the convention technology and the system and method of the present disclosure is that in the present disclosure the plurality of sensors are respectively installed at spaces of the house, the measuring data of the sensors are collected by the data collection client, and the serve analyzes the measuring data and spatial information corresponding thereto to generate the suggestion analysis result, whereby the diagnosis for statuses of the spaces of the house can be provided.

Therefore, the technical effect of providing the intelligent diagnosis for the spaces of the house may be achieved.

### BRIEF DESCRIPTION OF THE DRAWINGS

The detailed structure, operating principle and effects of the present disclosure will now be described in more details hereinafter with reference to the accompanying drawings that show various embodiments of the present disclosure as follows.

FIG. 1 is a block diagram of a home-based intelligent analysis and suggestion system, in accordance with the present disclosure.

FIG. 2 is a flow chart of a home-based intelligent analysis and suggestion method, in accordance with the present disclosure.

FIG. 3 is a block diagram of architecture of the home-based intelligent analysis and suggestion system, in accordance with the present disclosure.

### DETAILED DESCRIPTION

Reference will now be made in detail to the exemplary embodiments of the present disclosure, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this disclosure will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way. The same reference numbers are used in the drawings and the description to refer to the same or like parts.

It will be understood that, although the terms ‘first’, ‘second’, ‘third’, etc., may be used herein to describe various elements, these elements should not be limited by these terms. The terms are used only for the purpose of distinguishing one component from another component. Thus, a first element discussed below could be termed a second element without departing from the teachings of embodiments. As used herein, the term “or” includes any and all combinations of one or more of the associated listed items.

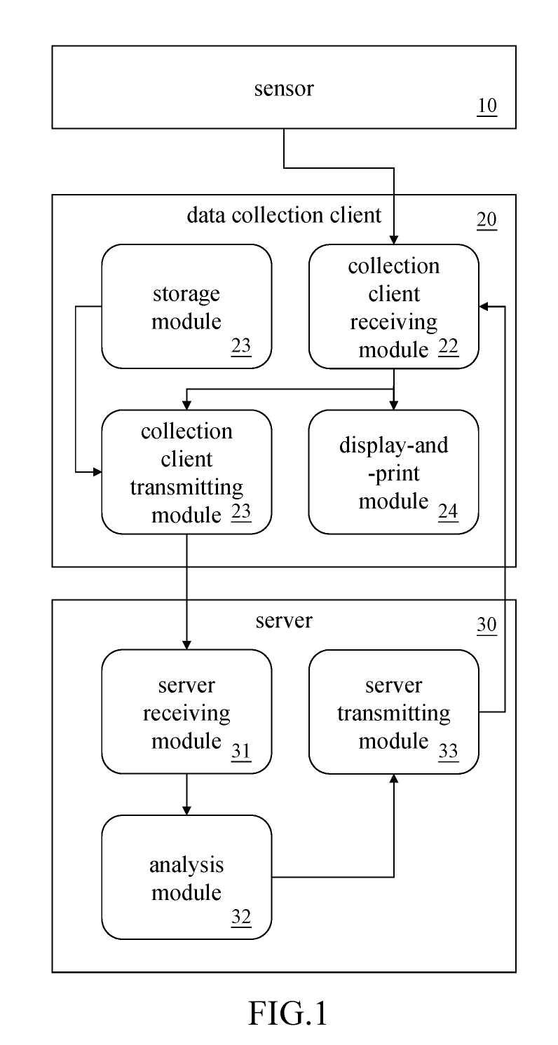

First, the home-based intelligent analysis and suggestion system, in accordance with the present disclosure, will be illustrated below. Please refer to FIG. 1 which shows a block diagram of a home-based intelligent analysis and suggestion system, in accordance with the present disclosure.

A system includes a plurality of sensors 10, a data collection client 20 and a server 30, and the data collection client 20 includes a storage module 21, a collection client receiving module 22, a collection client transmitting module 23 and a display-and-print module 24. The server 30 further includes a server receiving module 31, an analysis module 32 and a server transmitting module 33.

A plurality of sensors 10 are respectively installed in spaces of a house, and each is configured to measure different measuring data corresponding to each space. For example, the spaces of the house may include a room, the living room, a kitchen, a bathroom, and so on, and the sensors may include a humidity sensor, a temperature sensor, an illumination sensor and a current sensor, and so on; however, the application field of the present disclosure is not limited thereto.

The data collection client 20 is installed inside the house, the storage module 21 of the data collection client 20 stores spatial information of all spaces, and each of spatial information includes a space configuration and information of devices installed in the space. For example, the information of the devices installed in the space may include information of an air circulating device, an electronic device, a lighting device, and so on, and the air circulating device may include an air conditioner, an electric fan, a ventilator and so on, and the electronic device may include a computer, a television, an electronic heater and so on, and the lighting device may include a fluorescent lamp, a table lamp, a night lamp and so on; however, the application field of the present disclosure is not limited thereto.

Next, the collection client receiving module 22 of the data collection client 20 is configured to receive the measuring data measured by the sensors 10 installed in the spaces of the house through wireless transmission. For example, the wireless transmission used by the collection client receiving module 22 of the data collection client 20 includes wireless network and Wi-Fi; however, the application filed of the present disclosure is not limited thereto.

After the collection client receiving module 22 of the data collection client 20 receives the measuring data from the sensors 10, the collection client transmitting module 23 of the data collection client 20 transmits the measuring data and spatial information to the server 30 through the wireless transmission. For example, the wireless transmission used by the collection client transmitting module 23 of the data collection client 20 includes wireless network or Wi-Fi; however, the application field of the present disclosure is not limited thereto.

After the server receiving module 31 of the server 30 receives the measuring data and the spatial information, the analysis module 32 of the server 30 is configured to perform analysis based on the measuring data and the spatial information corresponding thereto, so as to generate a suggestion analysis result.

For example, the measuring data received by the server receiving module 31 of the server 30 from the collection client transmitting module 23 of the data collection client 20 is “a temperature of 35 degrees” and the spatial information is “air conditioner”, the analysis module 32 of the server 30 can perform analysis on the measuring data to determine that “the temperature of 35° C.” exceeds a preset temperature of 30° C., and then base the spatial information containing “air conditioner” to generate the suggestion analysis result as “suggest to turn on the air conditioner”.

For example, in particular, the measuring data and spatial information received by the server receiving module 31 of the server 30 from the collection client transmitting module 23 of the data collection client 20 are “current of 150 A”, and “computer, television, air conditioner, dehumidifier, hair dryer, and game console” respectively, and the analysis module 32 of the server 30 analyzes the measuring data to obtain a result that “the current of 150 A” exceeds “a preset current of 100 A”, and generate the suggestion analysis result as “suggest to turn off one of the computer, the television, the hair dryer and the game console”, based on the spatial information being “the computer, the television, the air conditioner, the dehumidifier, the hair dryer, and the game console”.

After the analysis module 32 of the server 30 generates the suggestion analysis result based on the measuring data and the spatial information, the server transmitting module 33 of the server 30 transmits the suggestion analysis result generated by the analysis module 32 of the server 30 to the data collection client 20.

In the data collection client 20, the collection client transmitting module 22 receives the suggestion analysis result from the server transmitting module 33 of the server 30, and the display-and-print module 24 of the data collection client 20 is configured to display and print the suggestion analysis result, so that the user can perform corresponding operation based on the suggest analysis result. Therefore, the system of the present disclosure can provide a diagnosis about the statuses of the spaces of the house.

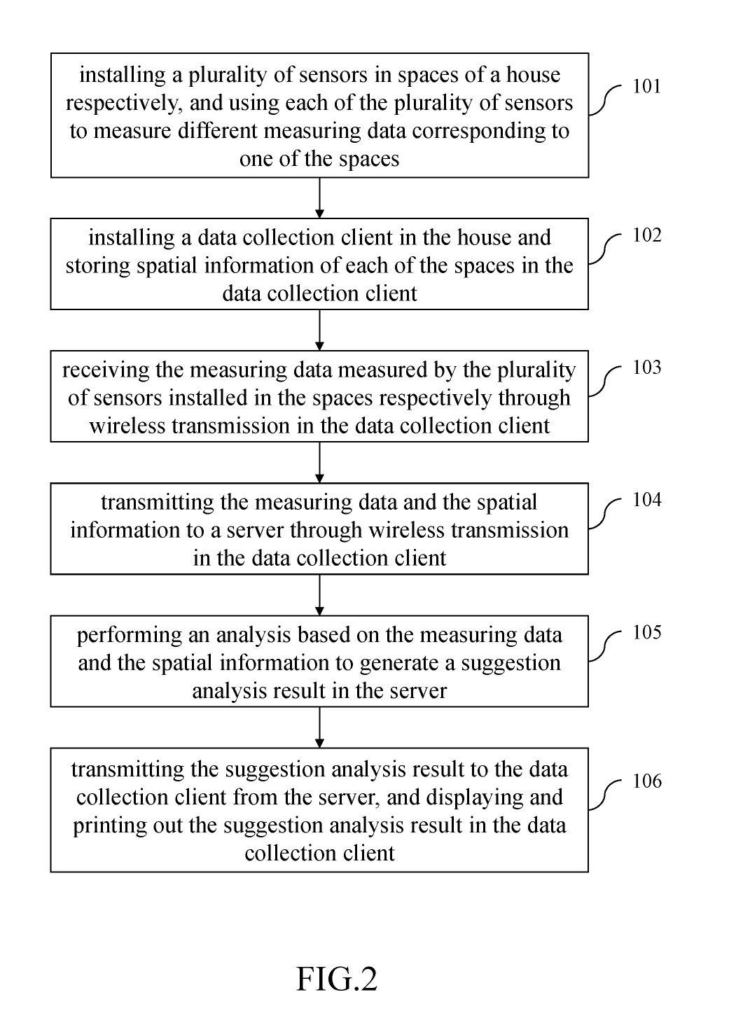

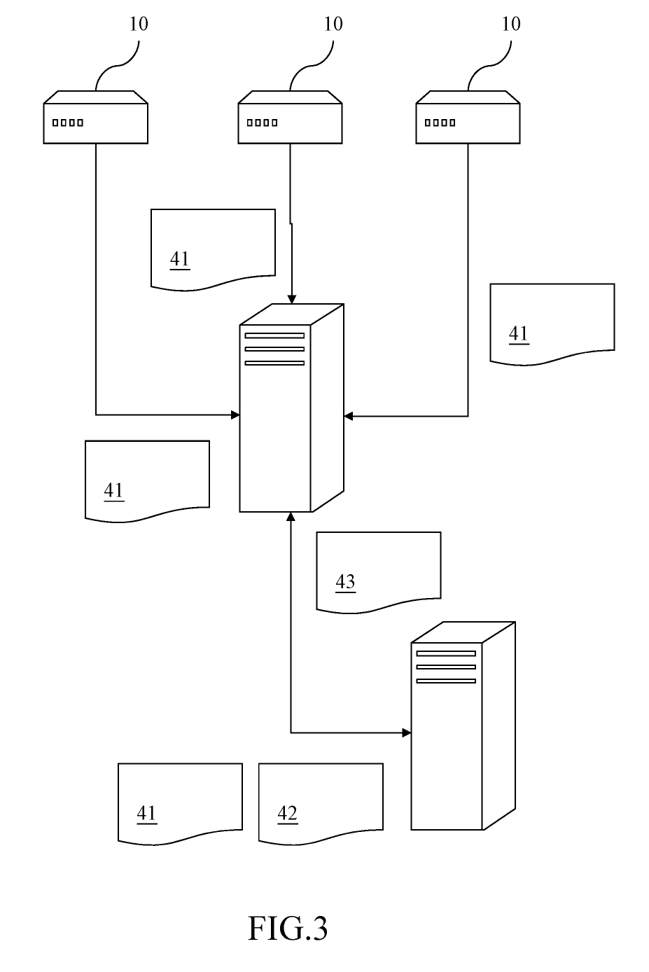

Please refer to FIGS. 1 through 3. FIG. 2 shows a flow chart of the home-based intelligence analysis and suggestion method, and FIG. 3 shows a schematic view of architecture of the home-based intelligence analysis and suggestion system.

The plurality of sensors 10 are respectively installed in the spaces of the house, and each sensor is configured to measure different measuring data 41 corresponding to one of the spaces (step 101). For example, in the embodiment the measuring data 41 is “current of 150 A”.

For example, the spaces of the house may include the room, the living room, the restaurant, the kitchen, the bathroom and so on, and the sensors may include the humidity sensor, the temperature sensor, the illumination sensor and the current sensor, and so on; however, the application field of the present disclosure is not limited thereto.

The data collection client 20 is installed inside the house, and the storage module 21 of the data collection client 20 stores the spatial information 42 of all spaces (step 102). For example, in the embodiment the spatial information 42 may include the computer, the television, the air conditioner, the dehumidifier, the hair dryer and the game console.

The spatial information 42 includes the space configuration and information of the devices installed in the space. For example, the information of the devices disposed in the space may include the information of the air circulating device, the electronic device, the lighting device and so on, and the air circulating device may include an air conditioner, an electric fan, a ventilator and so on, and the electronic device may include a computer, a television, an electronic heater and so on, and the lighting device may include a fluorescent lamp, a table lamp, a night lamp and so on; however, application field of the present disclosure is not limited thereto.

The collection client receiving module 22 of the data collection client 20 receives the measuring data 41 respectively measured by the sensors 10 installed in the spaces (step 103), for example, the measuring data 41 may indicate “current of 150 A”. For example, the wireless transmission used by the collection client receiving module 22 of the data collection client 20 includes wireless network or Wi-Fi; however, the application filed of the present disclosure is not limited thereto.

After from the sensor 10 the collection client receiving module 22 of the data collection client 20 receives the measuring data 41 indicating “the current of 150 A”, the measuring data 41 indicating “current of 150 A” and the spatial information 42 indicating “the computer, the television, the air conditioner, the dehumidifier, the hair dryer and the game console” received by the collection client transmitting module 23 of the data collection client 20 are transmitted to the server 30 through the wireless transmission (step 104). For example, the wireless transmission used by the collection client transmitting module 23 of the data collection client 20 includes wireless network or Wi-Fi; however, the application field of the present disclosure is not limited thereto.

After the server receiving module 31 of server 30 receives the measuring data 41 and the spatial information 42 from the collection client transmitting module 23 of the data collection client 20, the analysis module 32 of the server 30 performs the analysis based on the measuring data 41 and the spatial information 42 to generate the suggestion analysis result 43 (step 105).

In the embodiment, the measuring data 41 and the spatial information 42 received by the server receiving module 31 of the server 30 from the collection client transmitting module 23 of the data collection client 20 are “current of 150 A” and “the computer, the television, the air conditioner, the dehumidifier, the hair dryer, the game console” respectively, so that the analysis module 32 of the server 30 can analyze that the “current of 150 A” exceeds the preset current of 100 A, based on the measuring data 41, and generate the suggestion analysis result 43 as “suggest to turn off one of the computer, the television, the hair dryer and the game console”, based on the spatial information 42 indicating “the computer, the television, the air conditioner, the dehumidifier, the hair dryer, and the game console”.

After the analysis module 32 of the server 30 generates the suggestion analysis result 43 as “suggest to turn off one of the computer, the television, the hair dryer and the game console” based on the measuring data 41 and the spatial information 42, the server transmitting module 33 of the server 30 transmits the suggestion analysis result 43 indicating “suggest to turn off one of the computer, the television, the hair dryer and the game console” generated by the analysis module 32 of the server 30 to the data collection client 20.

After, through the collection client transmitting module 22 of the data collection client 20, the data collection client 20 receives the suggestion analysis result 43 of “suggest to turn off one of the computer, the television, the hair dryer and the game console” from the server transmitting module 33 of the server 30, the display-and-print module of the data collection client 20 displays and prints out the suggestion analysis result (step 106), whereby the user can perform corresponding operation based on the suggestion analysis result, and the diagnosis for the statuses of the spaces of the house can be provided.

The difference between the conventional technology and the system and method of the present disclosure is that in the present disclosure the plurality of sensors are respectively installed in the spaces of the house, and the data collection client collects the measuring data generated by the sensors, and the server then analyzes the measuring data and the spatial information corresponding thereto to generate the suggestion analysis result, whereby the diagnosis for statuses of the spaces of the house can be provided.

By means of the technology of the present disclosure, the conventional technology problem of the existing at-home intelligent diagnosis unable to diagnose the home environment can be solved, and the technical effect of providing the home-based intelligent diagnosis for the spaces of the house can be achieved.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

1. A home-based intelligent analysis and suggestion system, comprising:
a plurality of sensors installed in spaces of a house respectively, each of the plurality of sensors measuring different measuring data corresponding to one of the spaces;
a data collection client disposed in the house, and comprising:
a storage module storing spatial information of each of the spaces;
a collection client receiving module receiving the measuring data measured by the plurality of sensors installed in the spaces, through wireless transmission, and receiving a suggestion analysis result corresponding to the measuring data;
a collection client transmitting module transmitting the measuring data and the spatial information through wireless transmission; and
a display-and-print module displaying and printing out the suggestion analysis result; and
a server, comprising:
a server receiving module receiving the measuring data and the spatial information corresponding thereto, from the collection client transmitting module;
an analysis module performing an analysis based on the measuring data and the spatial information, to generate the suggestion analysis result; and
a server transmitting module transmitting the suggestion analysis result to the collection client receiving module.

2. The home-based intelligent analysis and suggestion system according to claim 1, wherein the plurality of sensors comprise a humidity sensor, a temperature sensor, an illumination sensor and a current sensor.

3. The home-based intelligent analysis and suggestion system according to claim 1, wherein the wireless transmission used by the collection client receiving module comprises wireless network and Wi-Fi.

4. The home-based intelligent analysis and suggestion system according to claim 1, wherein the wireless transmission used by the collection client transmitting module comprises wireless network and Wi-Fi.

5. The home-based intelligent analysis and suggestion system according to claim 1, wherein the spatial information comprises a space configuration and information of at least one device disposed in each of the spaces.

6. A home-based intelligent analysis and suggestion method, comprising:
installing a plurality of sensors in spaces of a house respectively, and using each of the plurality of sensors to measure different measuring data corresponding to one of the spaces;
installing a data collection client in the house and storing spatial information of each of the spaces in the data collection client;
receiving the measuring data measured by the plurality of sensors installed in the spaces respectively through wireless transmission in the data collection client;
transmitting the measuring data and the spatial information to a server through wireless transmission in the data collection client;
performing an analysis based on the measuring data and the spatial information to generate a suggestion analysis result in the server; and
transmitting the suggestion analysis result to the data collection client from the server, and displaying and printing out the suggestion analysis result in the data collection client.

7. The home-based intelligent analysis and suggestion method according to claim 6, in the step of installing the plurality of sensors in the spaces of the house respectively and using each of the plurality of sensors to measure the measuring data corresponding to one of the spaces, wherein the plurality of sensors comprise a humidity sensor, a temperature sensor, an illumination sensor and a current sensor.

8. The home-based intelligent analysis and suggestion method according to claim 6, in the step of in the data collection client receiving the measuring data measured by the plurality of sensors installed in the spaces respectively through wireless transmission, wherein the wireless transmission comprises wireless network and Wi-Fi.

9. The home-based intelligent analysis and suggestion method according to claim 6, in the step of in the data collection client transmitting the measuring data and the spatial information to a server through wireless transmission, wherein the wireless transmission comprises wireless network and Wi-Fi.

10. The home-based intelligent analysis and suggestion method according to claim 6, in the step of installing a data collection client in the house and storing spatial information of each of the spaces in the data collection client, wherein the spatial information comprises a space configuration and information of at least one device disposed in one of the spaces.
